(19) United States
(12) Patent Application Publication
(10) Pub. No.: US 2025/0038875 A1
(43) Pub. Date: Jan. 30, 2025

(54) Integrated C+L band ROADM architecture

(71) Applicant: Ciena Corporation, Hanover, MD (US)

(72) Inventors: Paul Chedore, Ottawa (CA); Jean-Luc Archambault, Ottawa (CA); David W. Boertjes, Nepean (CA)

(21) Appl. No.: 18/549,666

(22) PCT Filed: Jan. 31, 2022
(86) PCT No.: PCT/US2022/014563

§ 371 Date: Sep. 8, 2023

Related U.S. Application Data
(60) Provisional application No. 17/215,058, filed on Mar. 29, 2021.

(51) Int. Cl. H04J 14/02; G02B 6/293; H04Q 11/00

(52) U.S. Cl. CPC H04J 14/0213; G02B 6/29383; H04J 14/02122; H04Q 11/0005

(57) ABSTRACT

An integrated C+L band Reconfigurable Optical Add/Drop Multiplexer, ROADM, node (10B, 10C, 10D) supporting integrated C and L band functionality includes one or more ROADM modules (20CL, 20CLQ) each including a demultiplexer Wavelength Selective Switch, WSS, (102) having a common receive input and a plurality of output ports, a multiplexer WSS (104) having a plurality of input ports and a common transmit output, wherein, each of the demultiplexer WSS (102) and the multiplexer WSS support (104) both the C band and L band in an integrated manner, a plurality of amplifiers (106, 108, 11, 112, 114, 116) that each connect to one of the demultiplexer WSS (102) and the multiplexer WSS (104), and line ports including a transmit port (50T) and a receive port (50R) that connect to the plurality of amplifiers (106, 108, 110, 112, 114, 116).

### CROSS-REFERENCE TO RELATED APPLICATION(S)

The present disclosure is a continuation-in-part of U.S. patent application Ser. No. 17/215,058, filed Mar. 29, 2021, the contents of which are incorporated by reference in their entirety.

### FIELD OF THE DISCLOSURE

The present disclosure generally relates to optical networking. More particularly, the present disclosure relates to systems and methods a C+L band Reconfigurable Optical Add/Drop Multiplexer (ROADM) architecture, including an integrated and bandless C&L ROADM degree architecture and a bandless C&L colorless and directionless (CD) multiplexer and demultiplexer design, as well as an integrated band splitter for scaling a dual band ROADM.

### BACKGROUND OF THE DISCLOSURE

Optical networks utilize Reconfigurable Optical Add-Drop Multiplexers (ROADMs) to realize selective and reconfigurable add/drop of wavelengths or spectrum locally and between various degrees. ROADMs generally utilize Wavelength Selective Switches (WSSs) in different configurations. A ROADM is a key building block forming a terminal where there is local add/drop of optical channels and where there is routing of optical channels between multiple degrees. The optical channels are located on optical spectrum that typically includes the C-band (˜1530 nm-1565 nm) and the L-band (˜1565 nm-1625 nm). Initial deployments were confined to the C-band only. As capacity has increased, so have optical networks to include both C-band and the L-band. Conventional deployments of an optical networking system utilizing the C-band and the L-band utilize separate equipment components. That is, there is typically a splitter/combiner and parallel sets of equipment for the C-band and for the L-band. While this approach scales capacity on the optical fiber, it requires 2× equipment and really is two parallel systems sharing the same fibers. As C+L band systems become common, there is a drive towards integrated equipment to reduce the duplication of equipment as well as to treat a C+L band system as a single line system operationally. While this reduces the amount of equipment required, there is a trade-off in terms of add/drop capacity in a ROADM. For example, integrating C+L band equipment in degree components (e.g., a Wavelength Selective Switch (WSS)) in a ROADM reduces the amount of local add/drop at the ROADM.

To support integrated C+L band equipment in a ROADM, there is a need to address the local add/drop scalability. Also, as more operators are deploying C+L band systems, there is a drive for full integration to support operational simplicity, reduced equipment cost, simplified equipment ordering and maintenance, and the like.

### BRIEF SUMMARY OF THE DISCLOSURE

The present disclosure relates to systems and methods a C+L band Reconfigurable Optical Add/Drop Multiplexer (ROADM) architecture, including an integrated and bandless C&L ROADM degree architecture and a bandless C&L colorless and directionless (CD) multiplexer and demultiplexer design, as well as an integrated band splitter for scaling add/drop in a dual band ROADM. The fundamental approach of the integrated C+L band ROADM architecture described herein is to treat both the C and L bands are being in the same system, i.e., not two parallel systems. The integrated C+L band ROADM architecture can be realized in modules that support both the C and L band. Advantages include lower cost, less complexity, simplified engineering, cookie cutter design and planning, and the like.

In an embodiment, a Reconfigurable Optical Add/Drop Multiplexer (ROADM) node supporting integrated C and L band functionality includes one or more ROADM modules each including a demultiplexer Wavelength Selective Switch (WSS) having a common receive input and a plurality of output ports, a multiplexer WSS having a plurality of input ports and a common transmit output, wherein, each of the demultiplexer WSS and the multiplexer WSS support both the C band and L band in an integrated manner, a plurality of amplifiers that each connect to one of the demultiplexer WSS and the multiplexer WSS, and line ports including a transmit port and a receive port that connect to the plurality of amplifiers.

The plurality of amplifiers can include two pre amplifiers and two post amplifiers, each amplifier supporting one of the C band and L band. The plurality of amplifiers can include one pre amplifier and one post amplifiers, each amplifier supports both the C band and L band. The one or more ROADM modules can further include an Optical Service Channel (OSC) located between the plurality of amplifiers and the line ports. The one or more ROADM modules can further include an Optical Time Domain Reflectometer (OTDR) located between the plurality of amplifiers and the line ports. The one or more ROADM modules can further include a plurality of Optical Channel Monitors (OCMs) connected to the plurality of amplifiers.

The ROADM node can further include one or more channel multiplexers/demultiplexers connected to the plurality of output ports and the plurality of input ports. The one or more channel multiplexers/demultiplexers can support channels from both the C band and the L band. The ROADM node can further include one or more fiber interconnection modules between the one or more ROADM modules and the one or more channel multiplexers/demultiplexers support. The one or more ROADM modules each can further include a second demultiplexer WSS and a second multiplexer WSS.

In another embodiment, a method of providing a Reconfigurable Optical Add/Drop Multiplexer (ROADM) node supporting integrated C and L band functionality includes providing one or more ROADM modules each including a demultiplexer Wavelength Selective Switch (WSS) having a common receive input and a plurality of output ports, a multiplexer WSS having a plurality of input ports and a common transmit output, wherein, each of the demultiplexer WSS and the multiplexer WSS support both the C band and L band in an integrated manner, a plurality of amplifiers that each connect to one of the demultiplexer WSS and the multiplexer WSS, and line ports including a transmit port and a receive port that connect to the plurality of amplifiers.

Also, the present disclosure relates to systems and methods for integrated band splitter for scaling a dual-band Reconfigurable Optical Add/Drop Multiplexer (ROADM). The present disclosure addresses port scalability in integrated C+L band equipment through a band splitter in between the ROADM components and the channel multiplexer/demultiplexer components. With the use of the band splitter, any port can be either C+L band thereby recovering ports. As noted above, integrated C+L band equipment causes a reduction in the number of ports.

In an embodiment, a degree in a Reconfigurable Optical Add/Drop Multiplexer (ROADM) includes ROADM components including a line port and a plurality of connection ports; channel multiplexer/demultiplexer components including degree ports and local add/drop ports; and one or more band splitters in between the ROADM components and the channel multiplexer/demultiplexer components. The ROADM components can include integrated C-band and L-band functionality. The ROADM components can include integrated C-band and L-band functionality and the channel multiplexer/demultiplexer components are separate for the C-band and L-band functionality. The ROADM components can include a Wavelength Selective Switches (WSS) that supports integrated C-band and L-band functionality.

Each of the one or more band splitters can include three ports with a common port configured to connect to one of the plurality of connection ports, a C-band port configured to connect to a degree port of C-band channel multiplexer/demultiplexer components, and an L-band port configured to connect to a degree port of L-band channel multiplexer/demultiplexer components. The band splitter can be configured to split/combine C-band spectrum and L-band spectrum. The band splitter can be a passive fiber device. The band splitter can be integrated into a fiber shuffler located between the ROADM components and the channel multiplexer/demultiplexer components.

In another embodiment, a Reconfigurable Optical Add/Drop Multiplexer (ROADM) node includes one or more degrees configured to connect to optical fibers in an optical network, each of the one or more degrees include ROADM components including a line port and a plurality of connection ports; channel multiplexer/demultiplexer components including degree ports and local add/drop ports; and one or more band splitters in between the ROADM components and the channel multiplexer/demultiplexer components. The ROADM components can include integrated C-band and L-band functionality. The ROADM components can include integrated C-band and L-band functionality and the channel multiplexer/demultiplexer components are separate for the C-band and L-band functionality.

The ROADM components can include a Wavelength Selective Switches (WSS) that supports integrated C-band and L-band functionality. Each of the one or more band splitters can include three ports with a common port configured to connect to one of the plurality of connection ports, a C-band port configured to connect to a degree port of C-band channel multiplexer/demultiplexer components, and an L-band port configured to connect to a degree port of L-band channel multiplexer/demultiplexer components. The band splitter can be configured to split/combine C-band spectrum and L-band spectrum. The band splitter can be a passive fiber device. The band splitter can be integrated into a fiber shuffler located between the ROADM components and the channel multiplexer/demultiplexer components. Degree-to-degree connectivity can be via connections between the connection ports of the respective degrees.

In a further embodiment, a method includes providing ROADM components including a line port and a plurality of connection ports for connectivity to an optical network; providing channel multiplexer/demultiplexer components including degree ports and local add/drop ports for local add/drop; and utilizing one or more band splitters in between the ROADM components and the channel multiplexer/demultiplexer components for scaling add/drop connectivity to the ROADM components. The ROADM components can include integrated C-band and L-band functionality and the channel multiplexer/demultiplexer components are separate for the C-band and L-band functionality. Each of the one or more band splitters can include three ports with a common port configured to connect to one of the plurality of connection ports, a C-band port configured to connect to a degree port of C-band channel multiplexer/demultiplexer components, and an L-band port configured to connect to a degree port of L-band channel multiplexer/demultiplexer components.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of a conventional C+L band ROADM degree where the C-band and L-band equipment is separate.

FIG. 2 is a block diagram of a C+L band ROADM degree where the C-band and L-band equipment share equipment including a WSS and have reduced local add/drop capability.

FIG. 3 is a block diagram of a C+L band ROADM degree where the C-band and L-band equipment share degree equipment and have improved local/add drop capability based on an inline band splitter.

FIG. 4 is a block diagram of a C+L band ROADM degree where the C-band and L-band equipment share degree and local add/drop equipment.

FIG. 5 is a block diagram illustrating a band splitter in between the ROADM module and the channel multiplexer/demultiplexer modules.

FIG. 6 is a block diagram of example components in separate C-band and L-band ROADM modules.

FIGS. 7A and 7B are block diagrams of example components in an integrated C+L band ROADM module, with FIG. 7A illustrating the ROADM module with integrated C+L band WSS and separate amplifiers for the C and L band, and with FIG. 7B illustrating integrated C+L band amplifiers.

FIGS. 7C and 7D are block diagrams of an integrated C+L ROADM module with a quad WSS, for a 2-degree (2D) ROADM module.

FIG. 8 is a flowchart of a process for an integrated band splitter for scaling a dual-band ROADM.

FIG. 9 is a block diagram of a conventional C+L (non-integrated ROADM).

FIG. 10 is a block diagram of a first step towards C+L integration where the ROADM is integrated but the channel multiplexer/demultiplexer components are still separate.

FIG. 11 is a block diagram of integrated channel multiplexer/demultiplexer components.

FIGS. 12-15 illustrate various embodiments of the integrated multiplexer/demultiplexer module supporting add/drop for channels in both the C band and L band, FIG. 12 is a block diagram of a colorless/directionless module 200, FIG. 13 is a block diagram of a colorless/directionless/contentionless module, FIG. 14 is a block diagram of another colorless/directionless/contentionless module using an M×N multicast switch (MCS), and FIG. 15 is a block diagram of another colorless/directionless/contentionless module using a 1×N contentionless WSS (CWSS).

FIG. 16 is a block diagram of an integrated C+L band amplifier including Raman amplification, for a line amplifier.

### DETAILED DESCRIPTION OF THE DISCLOSURE

Again, the present disclosure relates to systems and methods a C+L band Reconfigurable Optical Add/Drop Multiplexer (ROADM) architecture, including an integrated and bandless C&L ROADM degree architecture and a bandless C&L colorless and directionless (CD) multiplexer and demultiplexer design, as well as a C&L colorless direct attach (CDA) and colorless, directionless, and contentionless (CDC), as an integrated band splitter for scaling add/drop in a dual band ROADM. The fundamental approach of the integrated C+L band ROADM architecture described herein is to treat both the C and L bands are being in the same system, i.e., not two parallel systems. The integrated C+L band ROADM architecture can be realized in modules that support both the C and L band. Advantages include lower cost, less complexity, simplified engineering, cookie cutter design and planning, and the like.

Integrated band Splitter

Also, the present disclosure relates to systems and methods for integrated band splitter for scaling a dual-band Reconfigurable Optical Add/Drop Multiplexer (ROADM). The present disclosure addresses port scalability in integrated C+L band equipment through a band splitter in between the ROADM components and the channel multiplexer/demultiplexer components. With the use of the band splitter, any port can be either C+L band thereby recovering ports. As noted above, integrated C+L band equipment causes a reduction in the number of ports.

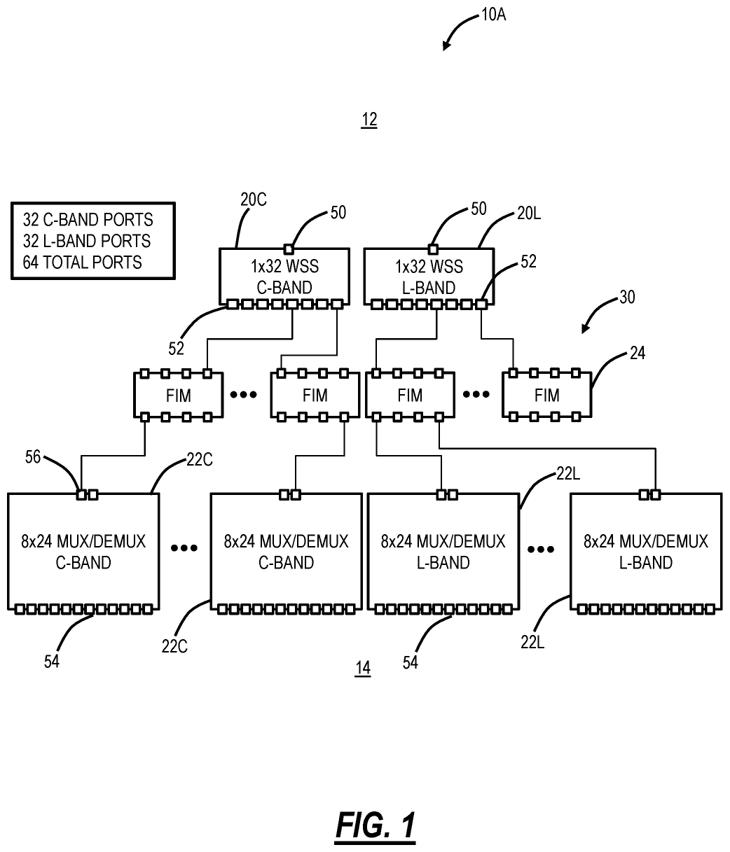

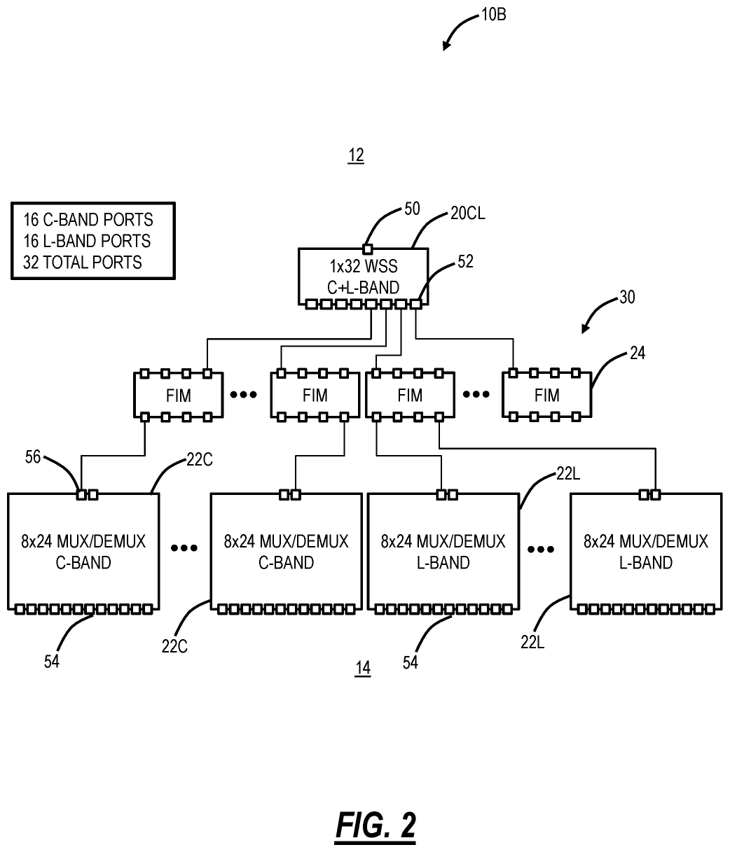

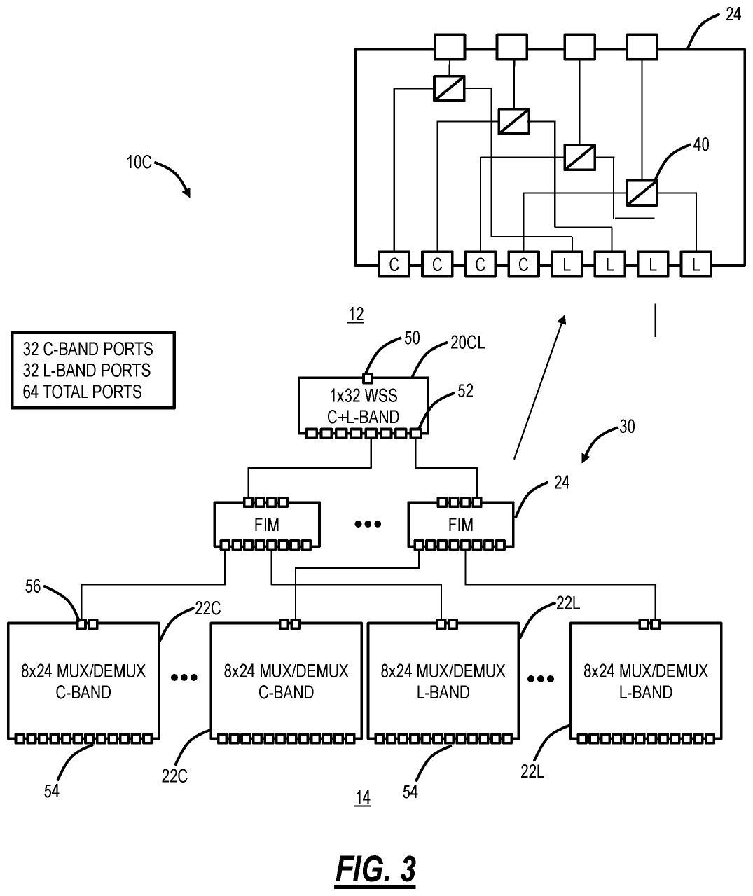

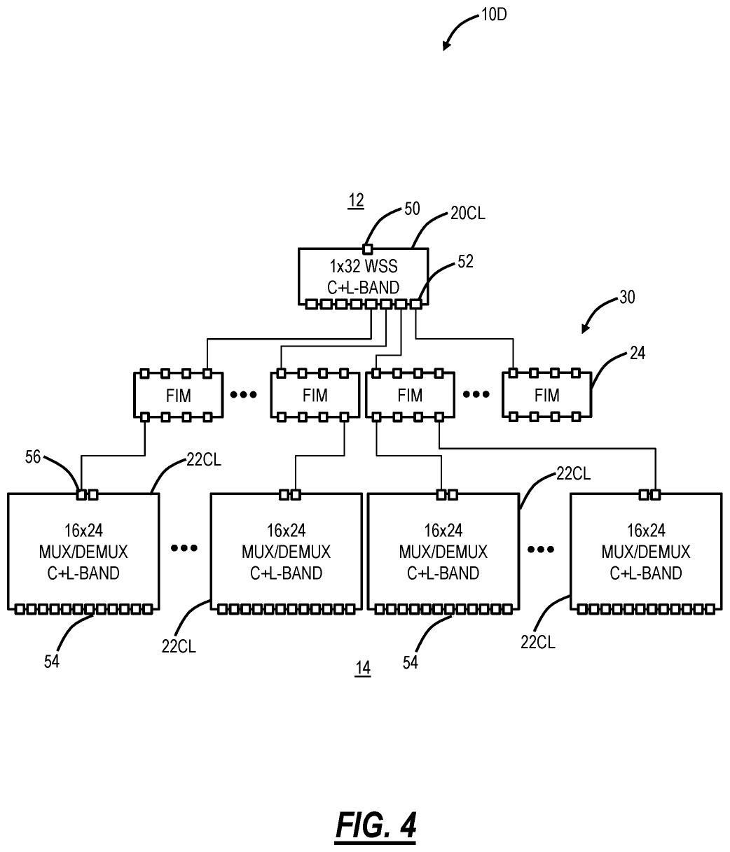

FIGS. 1-4 are block diagrams of a ROADM degree 10A, 10B, 10C, 10D. Specifically, FIG. 1 is a block diagram of a conventional ROADM degree 10A where the C-band and L-band equipment is separate. FIG. 2 is a block diagram of a ROADM degree 10B where the C-band and L-band equipment share equipment and have reduced local add/drop capability. FIG. 3 is a block diagram of a ROADM degree 10C where the C-band and L-band equipment share degree equipment and have improved local/add drop capability based on an inline band splitter 12. FIG. 4 is a block diagram of a ROADM degree 10D where the C-band and L-band equipment share degree and local add/drop equipment.

As is known in the art, a ROADM degree 10 includes various components for interfacing optical fibers at a terminal. Each network element can have one to N degrees, N being an integer. For example, a one-degree node interfaces a single adjacent node. A two-degree node interfaces two adjacent nodes, e.g., a logical East and West direction, a four-degree node interfaces four adjacent nodes, e.g., a logical North, South, East, and West direction, etc. ROADM deployments are scaling, and it is possible to have multiple degree nodes, including 16 degrees are more. FIGS. 1-4 each illustrate the architecture of a single degree, and those skilled in the art will recognize it can be duplicated multiple times as needed depending on the number of degrees.

The present disclosure relates to a ROADM architecture for dual-band operation. Note, traditionally, the most used bands in the optical spectrum are the C-band (˜1530 nm-1565 nm) and the L-band (˜1565 nm-1625 nm). Of course, there can be other bands as are known in the art. The ROADM degrees 10 in all of the FIGS. 1-4 each supports the C-band and the L-band for illustration purposes. Also, the ROADM degrees 10 in FIGS. 1-4 include various components labeled as N×M devices, N and M are integers, such as 1×32, 8×24, 16×24, etc. First, these numbers define port counts, such as 1 common port and 32 input/output ports. Second, those skilled in the art will recognize these numbers increase over time as components evolve, and future, higher density port counts are expected and contemplated herewith.

Functionally, the ROADM degree 10 includes a line side 12 and a local add/drop side 14 with intervening components therebetween. The ROADM degree 10 in FIGS. 1-4 is illustrated from the perspective of modules 20, 22, 24. Details of the components and functionality of each of the modules 20, 22, 24 is described herein, and the present disclosure contemplates different module implementations, integrations, etc. That is, the term module is used herein as typical deployments use different modules to house components. However, those skilled in the art will recognize the present disclosure contemplates any equivalent functions regardless of how integrated into modules. The modules include ROADM modules 20, channel multiplexer/demultiplexer modules 22, and fiber interconnect modules (FIM) 24.

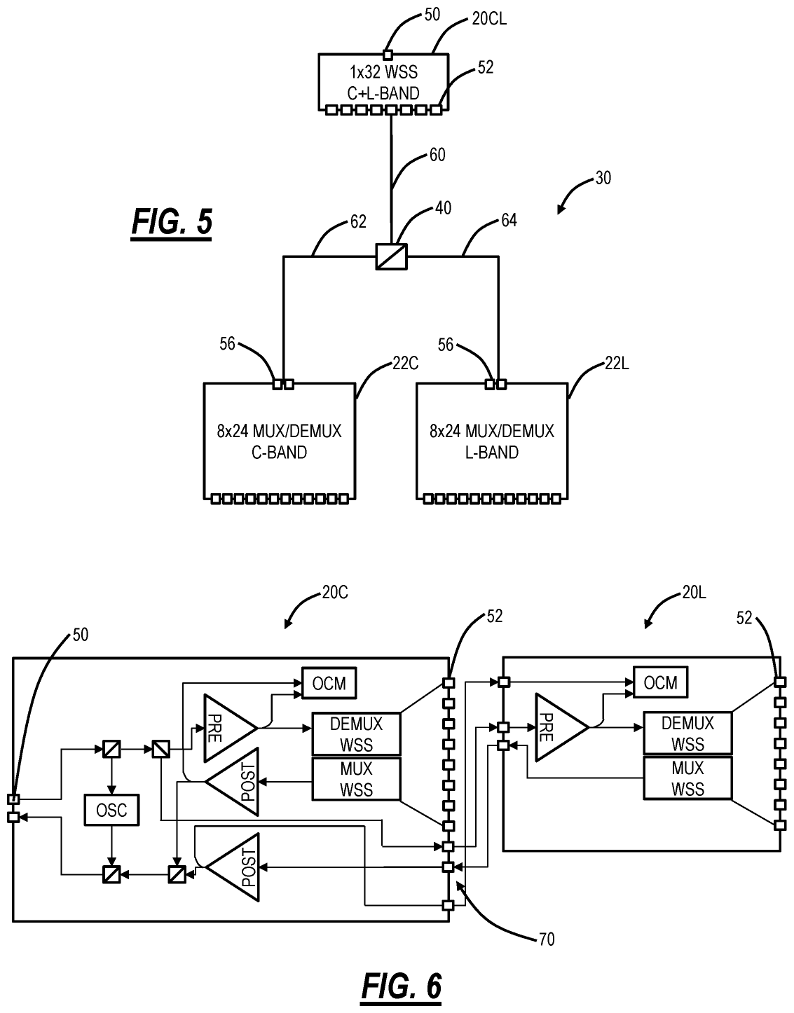

The ROADM modules 20 interfaces the line side 12 and can include, e.g., twin 1×32 flexible grid WSSs (one for transmit and one for receive), pre- and post-amplifiers such as Erbium-Doped Fiber Amplifiers (EDFAs), bi-directional Optical Time Domain Reflectometer (OTDR), Optical Channel Monitors (OCMs), Optical Service Channels (OSC), integrated Amplified Spontaneous Emission (ASE) sources for channel loading, and the like. The ROADM module 20 is referenced as a ROADM module 20C, 20L, 20CL where the suffix C, L, and CL denote the components support the C-band, the L-band, and both the C-band and the L-band in an integrated manner, respectively. FIGS. 5 and 6 illustrate internal components in example ROADM modules 20C, 20L, 20CL. The ROADM modules 20 are referred to as ROADM module as they provide the components to connect to external optical fibers for a degree and to fan out/in connections to other ROADM modules of other degrees for express connections and to the channel multiplexer/demultiplexer modules 22 for local add/drop.

The channel multiplexer/demultiplexer modules 22 interfaces the local add/drop side 14 connecting to local optical modems, transceivers, transponders, etc. The channel multiplexer/demultiplexer modules 22 also can include contentionless WSSs for interconnecting local add/drop channels to any degree (i.e., ROADM modules 20) for CDC-ROADM applications. Flexibility in add/drop requirements has led to so-called colorless, directionless, and optionally contentionless add/drop multiplexer structures, such as in ROADM devices, nodes, architectures, and structures. A colorless add/drop device supports any wavelength or spectral occupancy/band being added to any port of an add/drop device, i.e., ports are not wavelength specific. A directionless add/drop device supports any port being directed to any degree. Finally, a contentionless add/drop device supports multiple instances of the same channel (wavelength) in the same device (albeit to different degrees). A colorless, directionless add/drop device can be referred to as a CD device, and a colorless, directionless, and contentionless add/drop device can be referred to as a CDC device. Also, the channel multiplexer/demultiplexer modules 22 are referenced as modules 22C, 22L, 22CL, where the suffix C, L, and CL denote the components support the C-band, the L-band, and both the C-band and the L-band in an integrated manner, respectively. Also, the channel multiplexer/demultiplexer modules 22 are illustrated as a single layer, and those skilled in the art will recognize various different multiplexer/demultiplexer structures are possible, including layered approaches.

Finally, the fiber interconnect modules 24 are passive modules that support fiber connectivity between the ROADM modules 20 and the channel multiplexer/demultiplexer modules 22. That is, the fiber interconnect modules 24 is a fiber shuffler and can be used with high-density fiber cables such as Multi-fiber Push On (MPO) cables. The function here is to reduce cabling and provide a single point of interface similar to Fiber Distribution Panels (FDP). Of note, the fiber interconnect modules 24 can be referred to a fiber interconnect 30 between the ROADM modules 20 and the channel multiplexer/demultiplexer modules 22. Specifically, the present disclosure relates to a band splitter 40 in the fiber interconnect 30 or the fiber interconnect modules 24, and the present disclosure does not necessarily need the band splitter 40 in a module (the fiber interconnect modules 24) nor does the fiber interconnect 30 have to be in a module (the fiber interconnect modules 24).

The following describes connectivity between the modules 20, 22, 24. The illustrations in FIGS. 1-4 include single lines and a subset of the number of ports, for convenience of illustration. Those skilled in the art will recognize actually connectivity can include two lines (transmit and receive) for each connection and there are more ports than are shown, i.e., for a 1×32 ROADM module 20, for an 8×24 channel multiplexer/demultiplexer module 22, etc. That is, the term port used herein may refer to two connections (transmit and receive).

The ROADM modules 20 include a line port 50 that connects to external optical fibers, i.e. the line side 12, and a plurality of connection ports 52. The channel multiplexer/demultiplexer modules 22 include local add/drop ports 54 and degree ports 56. Note, the various ports are given different names to help distinguish. The local add/drop ports 54 ultimately connect to the local optical modems, transceivers, transponders, etc. There may also be inline pre-combiner devices as well, such as described in commonly-assigned U.S. patent application Ser. No. 16/567,023, filed Sep. 11, 2019, and entitled “Upgradeable colorless, directionless, and contentionless optical architectures,” the contents of which are incorporated by reference in their entirety. The degree ports 56 on the channel multiplexer/demultiplexer modules 22 connect to the connection ports 52 on the ROADM modules 20. Again, the fiber interconnection modules 24 are used to streamline the connections between the degree ports 56 and the connection ports 52, as a fiber shuffler supporting high-density cabling. Generally, the interconnectivity between the degree ports 56 and the connection ports 52 can be referred to as the fiber connectivity 20.

FIG. 1 illustrates the conventional ROADM degree 10A where the C-band and the L-band components are separate (namely parallel sets of components for each, even though they can be integrated in the same modules). Here, the conventional ROADM degree 10A includes two ROADM modules 20C, 20L, various channel multiplexer/demultiplexer modules 22C, 22L as needed for local add/drop, and the fiber interconnect 30, such as via the fiber interconnection modules 24. Note, because the ROADM degree 10A includes two ROADM modules 20C, 20L, there are a total of 64 of the connection ports 52.

Assuming a full-fill of each of the C-band and the L-band is 32 channels total per band or 64 channels total. If a node utilizing the ROADM degree 10A had eight degrees (8D) or twelve degrees (12D), the node would support 100% local add/drop. Now, for sixteen degrees (16D), the node would only support 75% local add/drop. That is, the more degrees, the more connection ports 52 are needed for degree-to-degree connectivity, thereby limiting the connectivity to the channel multiplexer/demultiplexer modules 22 for local add/drop. Stated differently, the connection ports 52 are used for either local add/drop or for degree-to-degree connectivity. Having separate C&L band ROADM modules 20C, 20L results in more available connection ports 52.

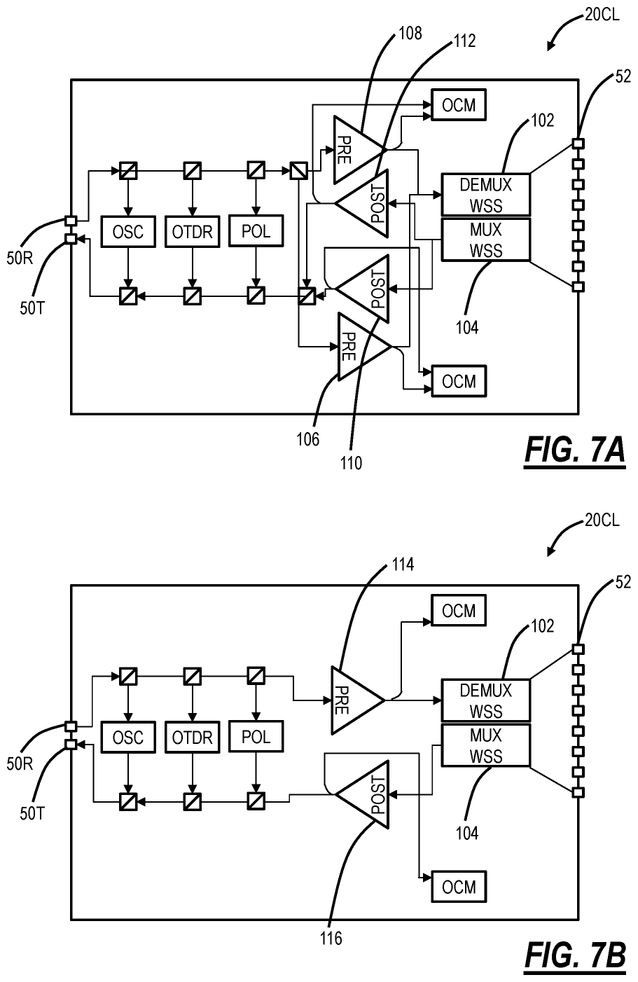

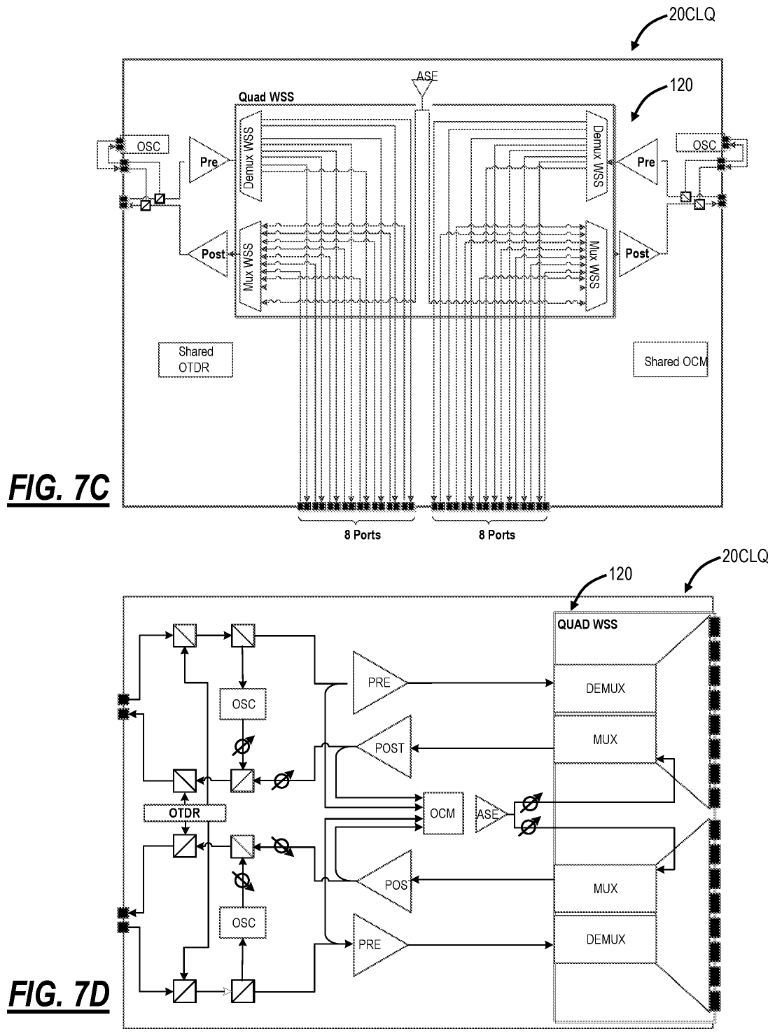

C&L band ROADM architectures are proving very popular as the need for bandwidth continues to grow. There is a desire for cost and component reduction to improve integration. The ROADM degree 10B in FIG. 2 illustrates the integration of the ROADM module 20CL. The ROADM module 20CL includes optical components that can support both the C-band and the L-band. The ROADM module 20CL is illustrated in FIG. 7. Of note, the ROADM modules 20 represent a sizeable portion of the ROADM cost structures, therefore, combining these functions in a single module can provide a meaningful cost reduction over the existing design. As is seen in FIGS. 6-7, the ROADM module 20CL only requires two WSSs versus four WSSs with the ROADM modules 20C, 20L.

While significantly reducing cost and components, the ROADM module 20CL effectively has half the number of connection ports 52 as with both the ROADM modules 20C, 20L, e.g., 32 connection ports 52 for the ROADM module 20CL versus 64 connection ports 52 for the ROADM modules 20C, 20L. The ROADM module 20CL shares the connection ports 52 across both bands. A given connection port 52 port would be C-band or L-band based on the channel multiplexer/demultiplexer modules 22C, 22L used.

Stated differently, in the parallel design of the ROADM degree 10A, there are 32 C-band ports 52 in the ROADM module 20C and 32 L-band ports 52 in the ROADM modules 20L which results in a total of 64 WSS ports. With the ROADM module 20CL approach, there are now 32 ports 52 in total across both bands. This results in a lower number of channel multiplexer/demultiplexer modules 22C, 22L attachment points causing a lower add/drop capacity.

Assuming the full-fill of each of the C-band and the L-band is 32 channels total per band or 64 channels total, as above. If a node utilizing the ROADM degree 10B had eight degrees (8D), the node would support 100% local add/drop. But, for twelve degrees (12D), the node would support 94% local add/drop, and, for sixteen degrees (16D), the node would only support 38% local add/drop. Thus, the cost reduction of the integrated ROADM module 20CL comes at the expense of reduced local add/drop capability.

The present disclosure addresses and recovers the local add/drop capability lost by reducing the port count in the ROADM module 20CL. Because the ROADM degree 10A has 2× the number of connection ports 52 as the ROADM degree 10B, it can connect to 2× the number of channel multiplexer/demultiplexer modules 22C, 22L, whereas the ROADM degree 10B can only connect to X the number of channel multiplexer/demultiplexer modules 22C, 22L.

To address add/drop scaling, the present disclosure contemplates use of a band splitter 40 in between the ROADM module 20CL and the channel multiplexer/demultiplexer modules 22C, 22L. FIG. 3 illustrates the band splitter 40 integrated in the fiber interconnect modules 24. FIG. 5 is a block diagram illustrating a band splitter 40 in between the ROADM module 20CL and the channel multiplexer/demultiplexer modules 22C, 22L, i.e., anywhere in the fiber interconnect 30. Effectively, the band splitter 40 enables the reduced connection port 52 ROADM module 20CL to connect to the same number of channel multiplexer/demultiplexer modules 22C, 22L as the higher connection port 52 ROADM modules 20C, 20L.

The band splitter 40 is a passive device that optically performs a 2:1 splitting and 1:2 combining of the C-band and the L-band. The band splitter 40 includes 3 ports 60, 62, 64 including a common port 60, a C-band port 62, and an L-band port 64. The common port 60 connects to one of the connection ports 52 on the ROADM module 20CL, the C-band port 62 connects to the channel multiplexer/demultiplexer module 22C, and the L-band port 64 connects to the channel multiplexer/demultiplexer module 22L.

With the band splitter 40, assuming a full-fill of each of the C-band and the L-band is 32 channels total per band or 64 channels total. If a node utilizing the ROADM degree 10C had 32-channels with eight degrees (8D) or twelve degrees (12D), the node would support 100% local add/drop. Now, for sixteen degrees (16D), the node would only support 75% local add/drop. That is, the ROADM degree 10C has the same add/drop capability as the ROADM degree 10A while having half the connection ports 52.

The first step in integration is the ROADM module 20CL, but FIG. 4 illustrates a fully-integrated solution for the ROADM degree 10D where both the ROADM module 20CL and the channel multiplexer/demultiplexer modules 22CL support both the C-band and the L-band. Here, there is also a reduction in the add/drop capability similar to the ROADM degree 10B.

In an embodiment, a degree 10A includes ROADM components 20CL including a line port 50 and a plurality of connection ports 52; channel multiplexer/demultiplexer components 22C, 22L including degree ports 56 and local add/drop ports 54; and one or more band splitters 40 in between the ROADM components 20CL and the channel multiplexer/demultiplexer components 22C, 22L.

The ROADM components 20CL can include integrated C-band and L-band functionality. The ROADM components 20CL can include integrated C-band and L-band functionality, and the channel multiplexer/demultiplexer components 22C, 22L are separate for the C-band and L-band functionality. The ROADM components 20CL can include two Wavelength Selective Switches (WSSs) that support integrated C-band and L-band functionality.

Each of the one or more band splitters 40 include three ports 60, 62, 64 with a common port 60 configured to connect to one of the plurality of connection ports 52, a C-band port 62 configured to connect to a degree port 56 of C-band channel multiplexer/demultiplexer components 20C, and an L-band port 64 configured to connect to a degree port 56 of L-band channel multiplexer/demultiplexer components 22L.

The band splitter 40 can be configured to split/combine C-band spectrum and L-band spectrum. The band splitter 40 can be a passive fiber device. The band splitter 40 can be integrated into a fiber shuffler 24 located between the ROADM components 20CL and the channel multiplexer/demultiplexer components 22C, 22L.

In another embodiment, a ROADM node includes one or more degrees 10C configured to connect to optical fibers in an optical network. Degree-to-degree connectivity is via connections between the connection ports 52 of the respective degrees 10C.

### Integrated ROADM

FIG. 6 is a block diagram of example components in the ROADM modules 20C, 20L. FIGS. 7A and 7B are block diagrams of example components in the ROADM module 20CL, with FIG. 7A illustrating the ROADM module 20CL with integrated C+L band WSS 102, 104 and separate amplifiers 106, 108, 110, 112 for the C and L band, and with FIG. 7B illustrating integrated C+L band amplifiers 114, 116. In FIG. 6, the ROADM modules 20C, 20L are illustrated in an upgradeable manner where the ROADM module 20C can be initially deployed and the ROADM module 20L can be added later as an upgrade. Here, the ROADM module 20L connects to upgrade ports 70 on the ROADM module 20C. Thus, the ROADM module 20L does not have its own port 50, but connects through the upgrade ports 70. Each of the ROADM modules 20C, 20L include two WSSs, one multiplexer (MUX) WSS and one demultiplexer (DEMUX) WSS, as well as pre-amplifiers and post amplifiers, OSC, and OCM.

The ROADM module 20CL includes only two WSSs that support spectrum across both the C-band and the L-band. As mentioned before, the WSSs are significant cost and the ROADM module 20CL reduces the number of WSSs by half.

In an embodiment, the integrated ROADM module 20CL includes components for bi-directional transmission (transmit and receive) over two fibers connected to ports 50R, 50T (where R is receive and T is transmit). The ROADM module 20CL is a single module that includes all components for both the C band and the L band. In the embodiments in both FIGS. 7A and 7B, the integrated ROADM module 20CL includes the two line side ports 50R, 50T, and a plurality of connection ports 52, for a combination of degree-to-degree interconnectivity and local add/drop.

In the embodiments in both FIGS. 7A and 7B, the integrated ROADM module 20CL includes the integrated C+L band WSS 102, 104. These WSSs 102, 104 operate similar to existing single band WSSs, but support an extended spectral range encompassing both the C and L bands.

In FIG. 7A, the ROADM module 20CL includes separate EDFA amplifiers 106, 108, 110, 112 for each of the C and L band. In FIG. 7B, the ROADM module 20CL includes an integrated amplifier 114, 116 that supports both the C and L band in an integrated manner. The integrated amplifier 114, 116 can include a semiconductor optical amplifier (SOA), Raman amplifier, or another type of doped amplifier.

The ROADM module 20CL can also include other components including an OSC, OTDR, polarimeter (POL), and OCM. These are connected by splitters. Those skilled in the art will recognize a typical implementation of the ROADM module 20CL does not necessarily require all of these components, and also may include additional components not listed here, such as an Amplified Spontaneous Emission (ASE) source for channel loading. Also, the OCM is shown separate for the C and L band, but the OCM can be a single device that supports/covers both bands.

### Integrated 2-Degree C+L ROADM Module

FIGS. 7C and 7D are block diagrams of an integrated C+L ROADM module 20CLQ with a quad WSS 120, for a 2-degree (2D) ROADM module. The quad WSS modules 120 are becoming available and offer an opportunity for better density and cost. The quad WSS 120 also supports integrated C+L band operation and enables 2-degrees on a same module, for shared benefits with the OCM, ASE, OTDR, etc. FIG. 7C illustrates connectivity in the quad WSS 120 whereas FIG. 7D illustrates connectivity between various functional components.

### Integrated Band Splitter Process

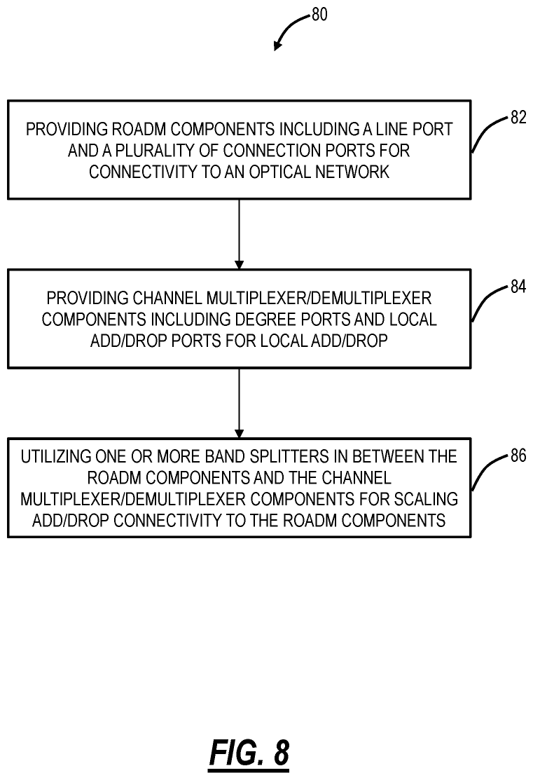

FIG. 8 is a flowchart of a process 80 for an integrated band splitter for scaling a dual band ROADM. The process 80 includes providing ROADM components including a line port and a plurality of connection ports for connectivity to an optical network (step 82); providing channel multiplexer/demultiplexer components including degree ports and local add/drop ports for local add/drop (step 84); and utilizing one or more band splitters in between the ROADM components and the channel multiplexer/demultiplexer components for scaling add/drop connectivity to the ROADM components (step 86).

The ROADM components can include integrated C-band and L-band functionality and the channel multiplexer/demultiplexer components are separate for the C-band and L-band functionality. Each of the one or more band splitters include three ports with a common port configured to connect to one of the plurality of connection ports, a C-band port configured to connect to a degree port of C-band channel multiplexer/demultiplexer components, and an L-band port configured to connect to a degree port of L-band channel multiplexer/demultiplexer components.

### Integrated C+L Band Evolution

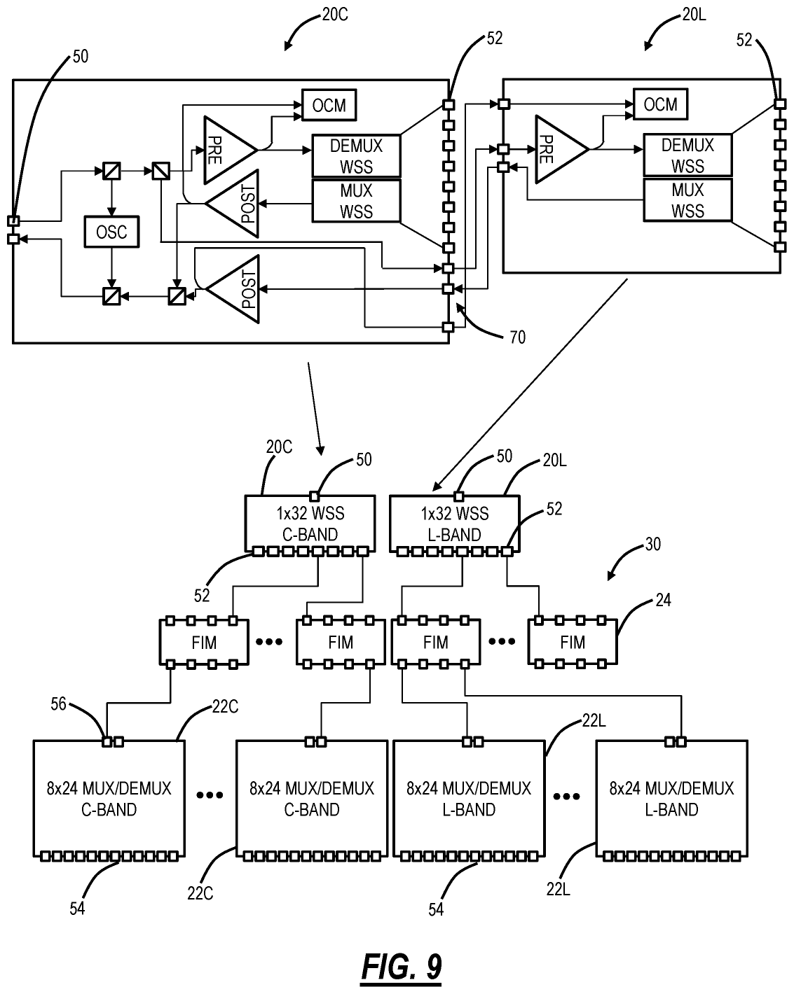

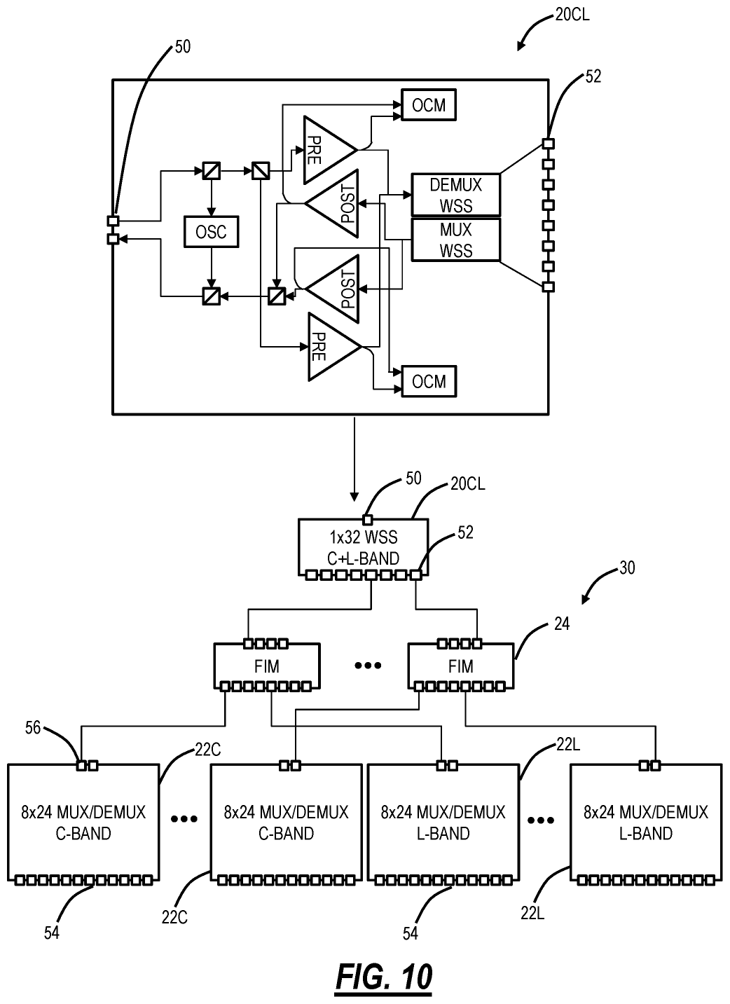

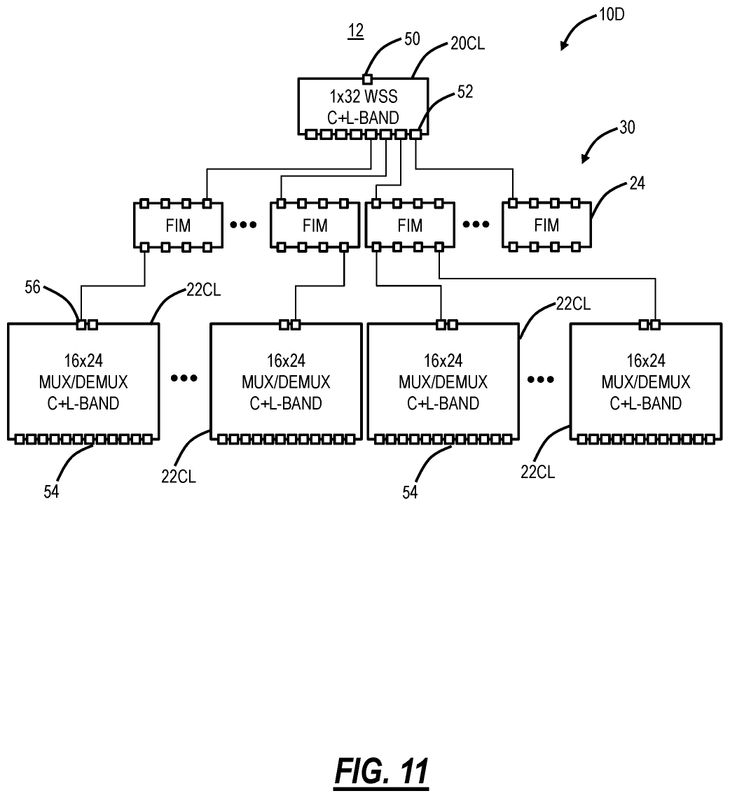

FIG. 9 is a block diagram of a conventional C+L (non-integrated ROADM). FIG. 10 is a block diagram of a first step towards C+L integration where the ROADM is integrated but the channel multiplexer/demultiplexer components are still separate. FIG. 11 is a block diagram of integrated channel multiplexer/demultiplexer components. FIGS. 9-11 are shown to illustrate the evolution from the current implementation (FIG. 9) to integrated C+L band implementations (FIGS. 10 and 11).

In FIG. 9, the ROADM degree includes two separate ROADM modules 20C, 20L (top of FIG. 9). Further, the multiplexer/demultiplexer modules 22C, 22L are also separate modules (bottom of FIG. 9), interconnected to the separate ROADM modules 20C, 20L via the fiber interconnect modules 24. That is, this is really two separate line systems that share the same fiber, but physically the modules 20, 22, 24 are separate.

In FIG. 10, the ROADM degree includes an integrated ROADM module 20CL (top of FIG. 10), as described in FIG. 7. Here, the fiber interconnect modules 24 connect to the single, integrated ROADM module 20CL, but the multiplexer/demultiplexer modules 22C, 22L are also separate modules (bottom of FIG. 9) remain separate. This is a partially integrated solution. Of note, the integrated band splitter 40 described herein addresses this partially integrated solution to reduce the port usage on the integrated ROADM module 20CL for add/drop.

FIG. 11 illustrates a full integrated C+L solution including the integrated ROADM module 20CL and multiplexer/demultiplexer modules 22CL.

### Integrated C+L Band Add/Drop

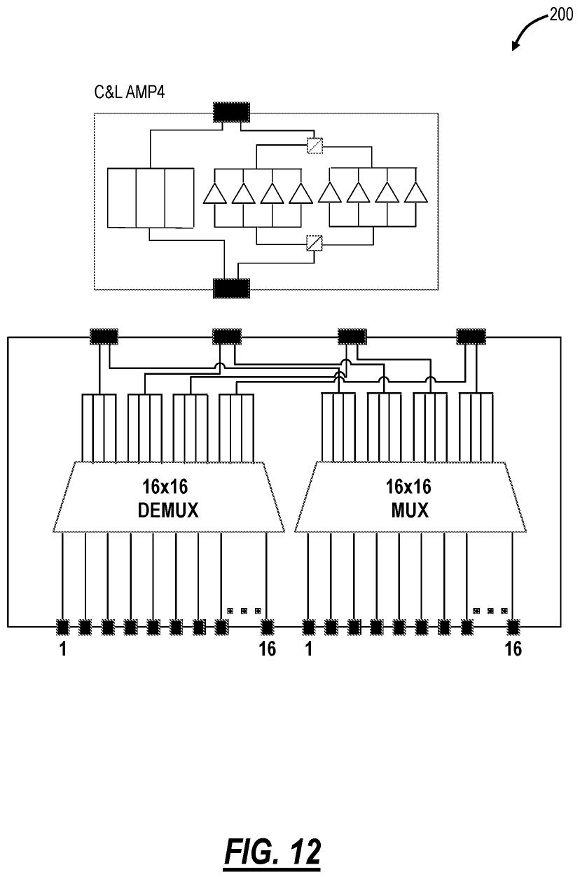

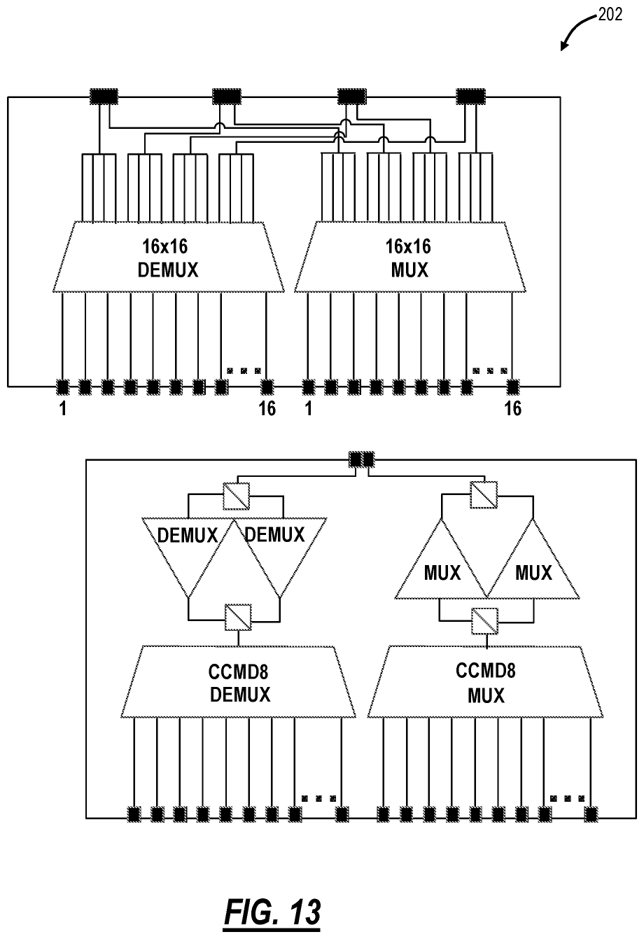

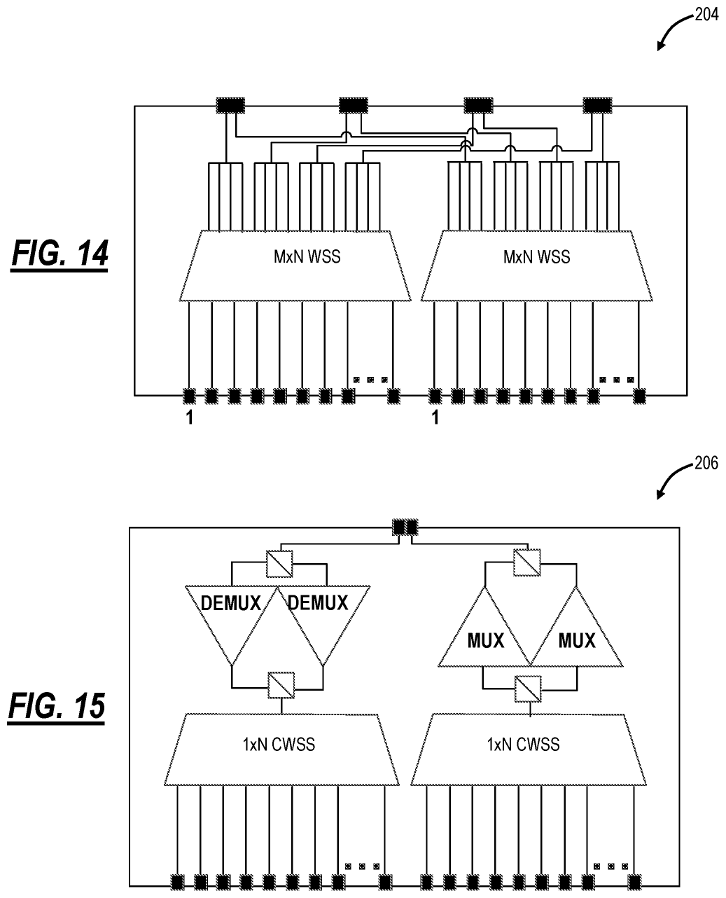

FIGS. 12-15 illustrate various embodiments of the integrated multiplexer/demultiplexer module 22CL supporting add/drop for channels in both the C band and L band. FIG. 12 is a block diagram of a colorless/directionless module 200, FIG. 13 is a block diagram of a colorless/directionless/contentionless module 202, FIG. 14 is a block diagram of another colorless/directionless/contentionless module 204 using an M×N multicast switch (MCS), and FIG. 15 is a block diagram of another colorless/directionless/contentionless module 206 using a 1×N contentionless WSS (CWSS).

In FIG. 12, the colorless/directionless module 200 includes N×N (e.g., 16×16) multiplexers and demultiplexers coupled to C and L band amplifiers. The module 200 can be a CD 16×16 using the same iC&L WSS as the ROADM module but this could also be a contentionless WSS (CWSS).

In FIG. 13, the colorless/directionless module 202 includes the N×N multiplexers and demultiplexers having C and L band amplifiers and channel multiplexers/demultiplexers on the input. In FIG. 14, the colorless/directionless module 204 includes a C+L band WSS, and in FIG. 15, the colorless/directionless module 206 includes the 1×N CWSS.

The multiplexer/demultiplexer modules connect to optical modems (not shown), which can support one of the C band and the L band, as well as cover both bands, i.e., C+L band modems.

### Integrated C+L Band Amplifier

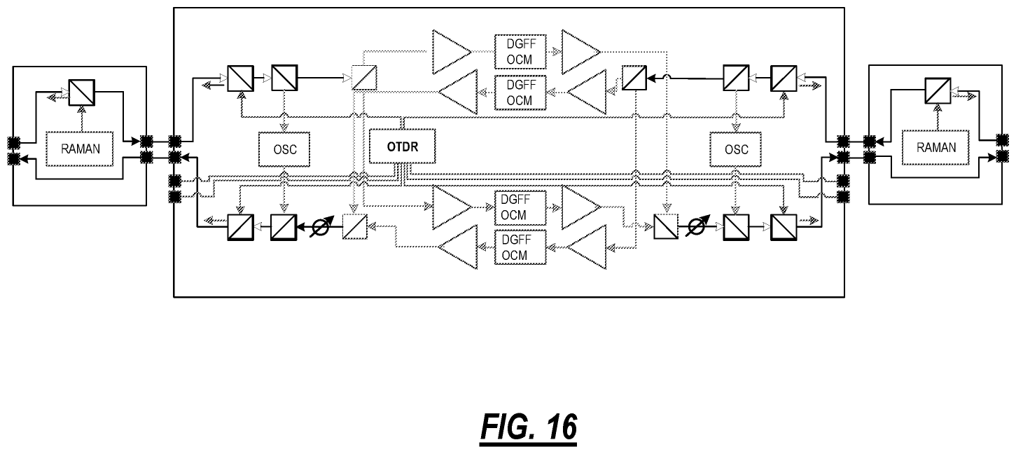

FIG. 16 is a block diagram of an integrated C+L band amplifier including Raman amplification, for a line amplifier. Of note, the amplifies can support both the C+L band, as well as the DGFFs, and OCMs.

### CONCLUSION

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, one or more processors, circuit, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

1-13. (canceled)

14. A Reconfigurable Optical Add/Drop Multiplexer (ROADM) node supporting integrated C and L band functionality, the ROADM node comprising:
one or more ROADM modules each including
a demultiplexer Wavelength Selective Switch (WSS) having a common receive input and a plurality of output ports,
a multiplexer WSS having a plurality of input ports and a common transmit output, wherein, each of the demultiplexer WSS and the multiplexer WSS support both the C band and L band in an integrated manner,
a plurality of amplifiers that each connect to one of the demultiplexer WSS and the multiplexer WSS, and
line ports including a transmit port and a receive port that connect to the plurality of amplifiers.

15. The ROADM node of claim 14, wherein the plurality of amplifiers two pre amplifiers and two post amplifiers, each amplifier supporting one of the C band and L band.

16. The ROADM node of claim 14, wherein the plurality of amplifiers include one pre amplifier and one post amplifier, each amplifier supports both the C band and L band.

17. The ROADM node of claim 14, wherein the one or more ROADM modules further include
an Optical Service Channel (OSC) located between the plurality of amplifiers and the line ports.

18. The ROADM node of claim 14, wherein the one or more ROADM modules further include an Optical Time Domain Reflectometer (OTDR) located between the plurality of amplifiers and the line ports.

19. The ROADM node of claim 14, wherein the one or more ROADM modules further include
a plurality of Optical Channel Monitors (OCMs) connected to the plurality of amplifiers.

20. The ROADM node of claim 14, wherein the one or more ROADM modules further include
one or more channel multiplexers/demultiplexers connected to the plurality of output ports and the plurality of input ports.

21. The ROADM node of claim 20, wherein the one or more channel multiplexers/demultiplexers support channels from both the C band and the L band on the plurality of output ports and the plurality of input ports.

22. The ROADM node of claim 20, wherein the integrated C and L band functionality includes support for both the C band and the L band on all ports associated with the one or more ROADM modules and the one or more channel multiplexers/demultiplexers.

23. The ROADM node of claim 20, further comprising
one or more fiber interconnection modules between the one or more ROADM modules and the one or more channel multiplexers/demultiplexers.

24. The ROADM node of claim 14, wherein the one or more ROADM modules further include
a second demultiplexer WSS and a second multiplexer WSS.

25. The ROADM node of claim 14, wherein the integrated C and L band functionality includes support for both the C band and the L band on all ports associated with the one or more ROADM modules.

26. A multiplexer/demultiplexer module for a Reconfigurable Optical Add/Drop Multiplexer (ROADM) comprising:
a plurality of local add/drop ports;
degree ports; and
multiplexer/demultiplexer components interconnecting the plurality of local add/drop ports to the degree ports, supporting at least two bands of spectrum.

27. The multiplexer/demultiplexer module of claim 26, wherein the at least two bands of spectrum include the C band and the L band.

28. The multiplexer/demultiplexer module of claim 26, wherein the multiplexer/demultiplexer components support colorless/directionless/contentionless functionality.

29. The multiplexer/demultiplexer module of claim 26, wherein the multiplexer/demultiplexer components include a contentionless wavelength selective switch (CWSS).

30. The multiplexer/demultiplexer module of claim 26, wherein the multiplexer/demultiplexer components include a M×N wavelength selective switch (WSS).

31. A degree in a Reconfigurable Optical Add/Drop Multiplexer (ROADM) comprising:
ROADM components including a line port and a plurality of connection ports;
channel multiplexer/demultiplexer components including degree ports and local add/drop ports; and
wherein all ports in between the ROADM components and the channel multiplexer/demultiplexer components include integrated C band and L band functionality.

32. The of claim 31, wherein the integrated C band and L band functionality includes the channel multiplexer/demultiplexer components being separate for the C band and L band functionality and one or more band splitters prior to the plurality of connection ports.

33. The of claim 31, wherein the ROADM components include a Wavelength Selective Switches (WSS) that supports integrated C-band and L-band functionality.
